(19) United States
(12) Patent Application Publication
(10) Pub. No.: US 2020/0000174 A1
(43) Pub. Date: Jan. 2, 2020

(54) FOOTWEAR UTILIZING FRICTION RIDGE PATTERNS

(71) Applicants: Donald PLANCE, Montrose, CA (US); Alan BACKUS, Los Angeles, CA (US)

(72) Inventors: Donald PLANCE, Montrose, CA (US); Alan BACKUS, Los Angeles, CA (US)

(21) Appl. No.: 16/025,366

(22) Filed: Jul. 2, 2018

(51) Int. Cl. A43B 5/00; A41D 19/00; A43B 13/22; A63B 60/06; F41C 23/16; E04F 15/02; B60R 13/00; B62D 29/04

(52) U.S. Cl. CPC A43B 5/00; A41D 19/00; A43B 13/223; A63B 60/06; A63B 59/50; E04F 15/02172; B60R 13/00; B62D 29/04; F41C 23/16

(57) ABSTRACT

Footwear, sports equipment, weapons, gloves, vehicle controls, floor surfaces, and vehicle tires three dimensionally imprinted with friction ridge patterns derived from individuals.

### TECHNICAL FIELD

This application relates generally to the design of human gripping and contact surfaces.

### BACKGROUND

Today there are a huge number of celebrity endorsed footwear products. The value of such endorsements has been predicated at least in part on the implication that endorsing celebrity had some influence on, or preference for, the design of the endorsed footwear. It might be useful to make the connection between an endorsing celebrity and the endorsed footwear more intimate, and thus increase the positive influence the endorsing celebrity has on the sales of the endorsed product.

Footwear tread design today is generally based on some combination of aesthetics, and measurement and design for specific, limited functional characteristics.

By contrast, athletic footwear in particular, and all footwear in general, are subjected to an infinite variety and sequences of only partially predictable forces. In the design of footwear, it might be useful to model gripping surfaces which have evolved in a dynamic gripping/contacting situation.

Friction ridges, also referred to as dermal ridges or dermal papillae, which comprise form patterns found on human fingertips, digital inner surfaces, palm surfaces (palmar); and lower toe surfaces, and the soles of feet (plantar), have evolved in dynamic gripping and contacting situations. What Charles Darwin described as “survival of the fittest” is predicated not just on gripping or gaining traction on an object or surface in a static situation, but rather on adapting and having a balance between gripping and contacting many, many different objects and surfaces, in an infinite variety and sequence of situations.

Due at least in part to the evolutionary development processes involved in the creation of friction ridge patterns, such patterns may ideally enhance the ability of surfaces mimicking friction ridge patterns to grip, gain traction and enhance control when contacting a variety of objects and surfaces in a wide diversity of only partially predictable situations.

### SUMMARY

FIGS. 1 through 35 show a variety of non-limiting and non-exhausted embodiments of the present application. These embodiments generally comprise footwear and other items three dimensionally imprinted with friction ridge patterns. Such friction ridge patterns may comprise patterns found on fingertips, digital inner surfaces, and/or palm surfaces, (sometimes referred to as palmar); and/or lower toe surfaces, and/or the soles of feet (sometimes referred to as plantar). These generally include such patterns found on humans, including specifically, but specifically not limited to, fingerprints.

They may also include such patterns found in analogous locations on various animals, including, but not limited to, primates, apes, great apes, and koalas.

They may also include such patterns which are logically derived, based on characteristics of naturally occurring friction ridge patterns.

Such patterns may be at 1-to-1 scale, or may be enlarged and/or reduced in scale.

Such patterns may also be distorted in various ways, including specifically, but not limited to, squeezing, skewing and/or bending.

Such friction ridge patterns may be regularly or irregularly repeated one or more times, on an entire surface, or on one or more portions of a surface.

Such friction ridge patterns may be isolated (FIGS. 8 and 9) or joined (FIGS. 13 and 16).

And such friction ridges may be placed on smooth surfaces (see FIGS. 8, 9, and 11), or on surfaces comprising several individual sub-contours, such as, by way of a non-limiting and non-exhausted example, several domes (see FIGS. 8, 9, and 10).

Such patterns may comprise regular, partially regular, or irregular mosaic structures (see FIGS. 13 and 16) with consistent (FIG. 13) or inconsistent (FIG. 16) scaling and forms.

And such patterns may be employed generally across lower footwear surfaces (as non-limiting and non-exhausted examples, FIGS. 2, 4, 6, 9, 14, 17), or to address specific areas of contact (FIGS. 19 and 20). The term friction ridge pattern as used herein shall refer to each and/or all of the foregoing.

Products employing such friction ridge patterns may be of conventional construction, utilizing conventional materials and fabrication techniques; or they may employ construction and materials specifically adapted to take advantage of such friction ridge patterns.

Virtually all or any footwear may advantageously employ such friction ridge patterns.

Such patterns may provide advantage at least for functional reasons, such as, by way of non-limiting and non-exhaustive examples, to improve contact and control between the soles of footwear and the surfaces they contact.

Such patterns may also provide advantage by providing a direct and easily understood connection between an individual and the footwear such patterns may be on. As a non-limiting and a non-exhaustive example, between a sports celebrity and a shoe the sports celebrity may endorse.

### BRIEF DESCRIPTION OF THE DRAWINGS

Various embodiments will become better understood with regard to the following description, appended claims and accompanying drawings wherein:

FIG. 1 is a side view of an athletic shoe.

FIG. 2 is a bottom view of the athletic shoe shown in FIG. 1.

FIG. 3 is a perspective of a loafer or slipper.

FIG. 4 is a bottom view of the loafer or slipper shown in FIG. 3.

FIG. 5 is a perspective of a men's dress shoe.

FIG. 6 is a bottom view of the dress shoe shown in FIG. 5.

FIG. 7 is a perspective view of a climbing shoe.

FIG. 8 is a detail of FIG. 9, as indicated in FIG. 9.

FIG. 9 is a bottom view of the climbing shoe shown in FIG. 7.

FIG. 10 is a section through the climbing shoe shown in FIG. 7, as indicated in FIG. 9.

FIG. 11 is an alternative section to the section shown in FIG. 10, taken through the climbing shoe shown in FIG. 7, as indicated in FIG. 9.

FIG. 12 is a perspective of a woman's shoe.

FIG. 13 is a detail of FIG. 14, as indicated in FIG. 14.

FIG. 14 is a bottom view of the woman's shoe shown in FIG. 12.

FIG. 15 is a perspective of a cross training athletic shoe.

FIG. 16 is a detail of FIG. 17, as indicated in FIG. 17.

FIG. 17 is a bottom view of the cross training athletic shoe shown in FIG. 15.

FIG. 18 is a perspective of a basketball shoe.

FIG. 19 is a detail of FIG. 20, as indicated in FIG. 20.

FIG. 20 is a bottom view of the basketball shoe shown in FIG. 18.

FIG. 21 is a perspective of a tennis racket.

FIG. 22 is a detail of FIG. 21, as indicated in FIG. 21.

FIG. 23 is a side view of a baseball bat.

FIG. 24 is a detail view of FIG. 23, as indicated in FIG. 23.

FIG. 25 is a side view of a golf club.

FIG. 26 is a side view of a pair of ski poles.

FIG. 27 is a detail view of FIG. 26, as indicated in FIG. 26.

FIG. 28 is a frontal view of a glove.

FIG. 29 is a side view of a pistol.

FIG. 30 is a side view of a rifle.

FIG. 31 is a perspective view of a car interior, including its steering wheel, shift lever, and accelerator and brake pedals.

FIG. 32 is a side view of a hockey stick.

FIG. 33 is a perspective of an exercise mat.

FIG. 34 is a side view of a military rifle.

FIG. 35 is a perspective of an automobile tire.

### DETAILED DESCRIPTION

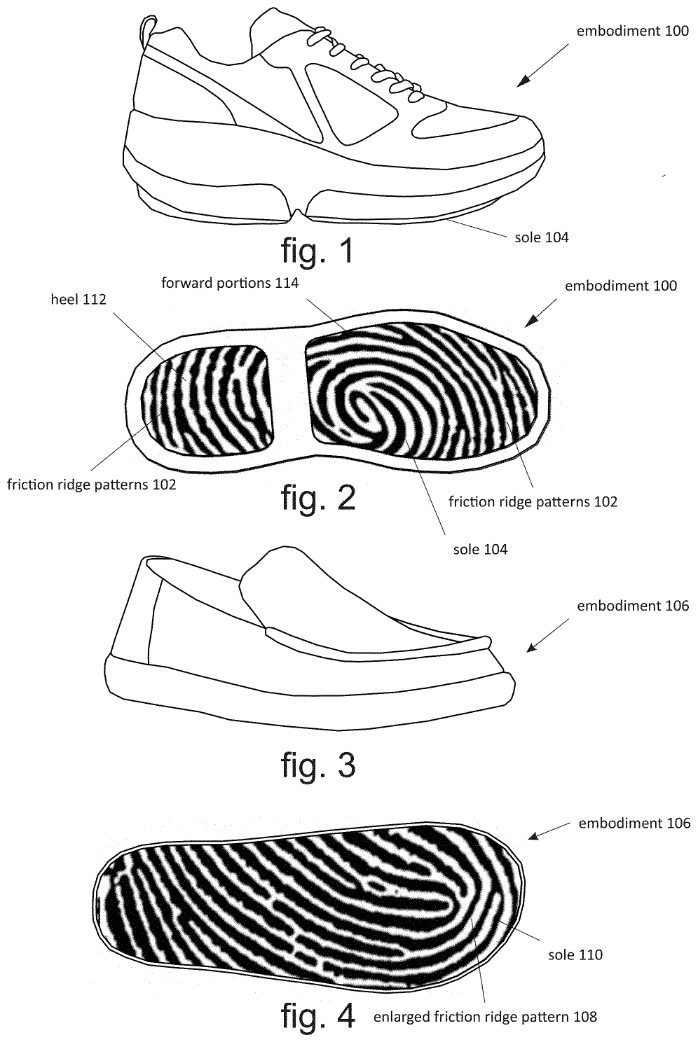

FIGS. 1 and 2 show embodiment 100 which is an athletic shoe. FIG. 2 shows a bottom view of the sole of embodiment 100 which utilizes enlarged friction ridge patterns 102 (FIG. 2) imprinted into sole 104.

FIGS. 3 and 4 show embodiment 106 which is a loafer or slipper. Embodiment 106 employs enlarged friction ridge pattern 108 three dimensionally imprinted into sole 110.

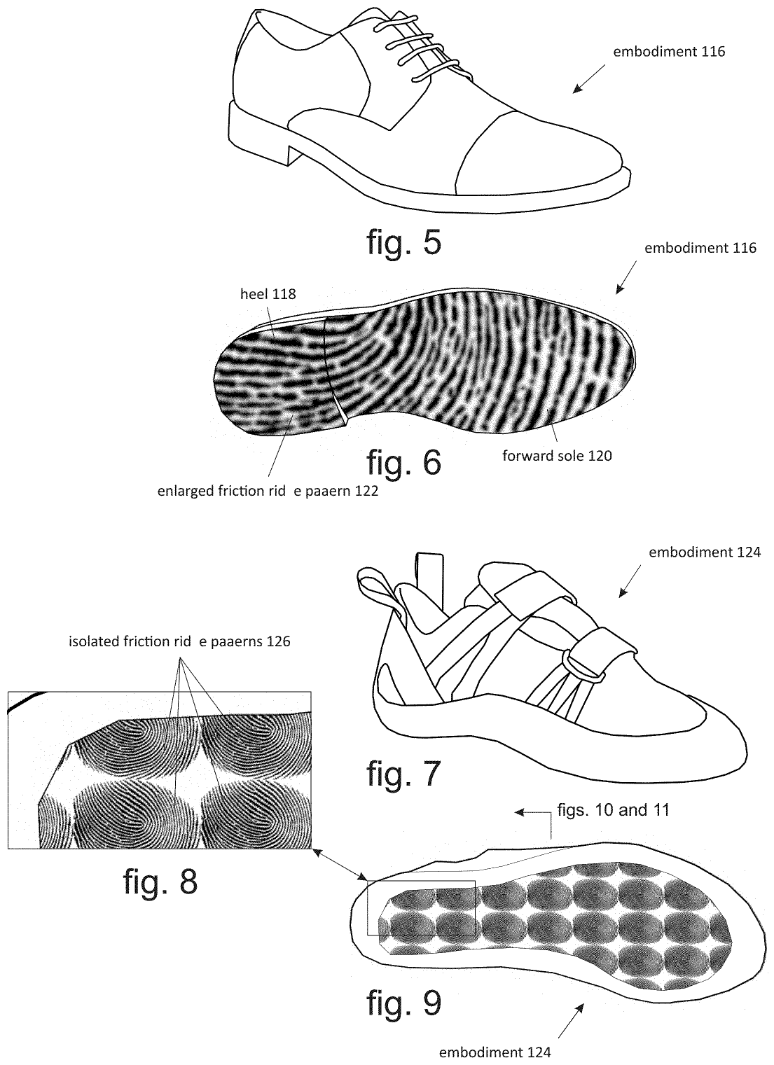

FIGS. 5 and 6 shows embodiment 116 which is a dress shoe imprinted on both its heel 118 and forward sole 120 with enlarged friction ridge pattern 122.

FIGS. 7, 8, and 9 show embodiment 124 which is a climbing shoe with isolated friction ridge patterns 126, based on full-size human fingerprints, repeat imprinted into its sole (FIGS. 8 and 9).

Each such imprint may be formed into a basically non-contoured sole 128 as shown in FIGS. 9 and 11.

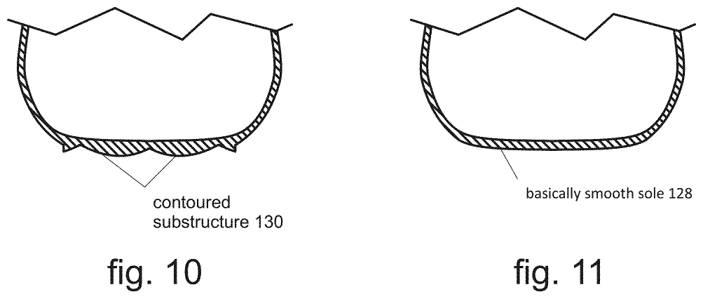

Alternatively, each fingerprint-like imprint may be formed into a contoured substructure 130 of its own, such as, as a non-limiting and non-exhausted example, the domed substructures shown in FIGS. 9 and 10.

Such contoured structures may overlap (not shown), or be isolated as shown in FIGS. 8 and 9.

Likewise, each contoured substructure may be unique, or may be partially or completely identical, or be rotated relative to one another, or be mixed with other similar or dissimilar contoured substructures in any of a variety of useful ways.

Further each contoured substructure may be of uniform size, or be of varying sizes.

Or one or more friction ridge patterns may be repeated or partially repeated or may be completely dissimilar, including, but not limited to, in size and/or scale, and/or its distortion relative to the origins it's based upon.

Or imprinted friction ridge patterns, and/or contoured substructure may be arranged and derived in any other useful ways.

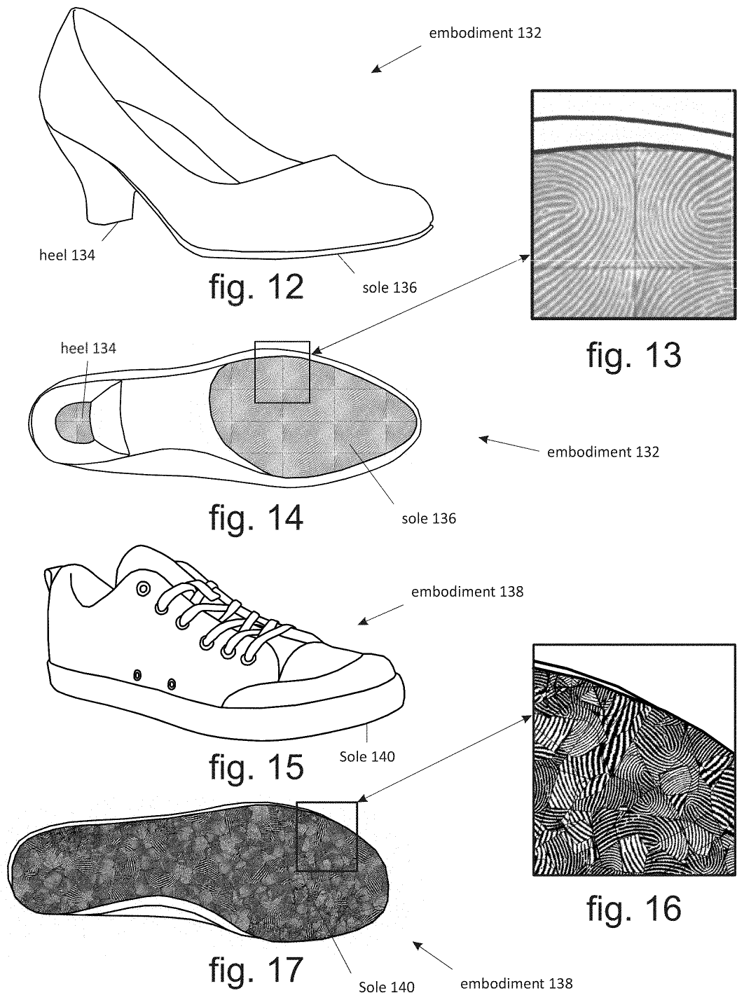

FIGS. 12, 13, and 14 show embodiment 132 which is a woman's shoe. As shown in FIGS. 13 and 14, and as a non-limiting and non-exhausted example, embodiment 132 has both its heel 134 and its sole 136 imprinted (FIG. 14) with rectangularly tiled friction ridge patterns.

Again, each such friction ridge pattern may be unique, or may be duplicated, or may be rotated to any angle, or may be produced at any scale, or may be distorted, or may be a derivative of any other useful organizational or distorting process.

Also, the rectangular tiling may be replaced with any other useful organizational structure. As non-limiting and non-exhausted examples, regular patterns of repeating geometric forms may be used, including, but not limited to, triangular, hexagonal, combinations of octagons and squares, tetrahedrons, other singular or combined regular or irregular polygons, irregular polygons, random forms, curved forms, or any other useful geometric structure.

The relief of such friction ridges may be of any useful contour or depth. As non-limiting and non-exhausted examples, such ridges may be the same as or greater or lesser in scaled depth than the natural occurring friction ridges from which the imprinted friction ridges are derived. Or the receding or advancing friction ridge sides may be perpendicular, or formed to duplicate the natural structure from which the friction ridges are derived, or be of any other useful form structure.

FIGS. 15, 16, and 17 show embodiment 138 which is cross training athletic shoe. Sole 140 is comprised of randomly sized, shaped, and scaled imprinted friction ridge patterns.

Such randomized patterns, as with virtually all patterns of friction ridges shown herein, might also be segregated into areas exhibiting specific characteristics.

As non-limiting and non-exhaustive examples, some areas might have friction ridges imprinted to greater depth to decrease the effects of expected wear. Or some areas might have friction ridges with greater or lesser thickness of sole underneath the friction ridge imprint to convey greater or lesser forces from the shoed foot to the bottom of the friction ridge. Or friction ridges might be segregated in other useful structures.

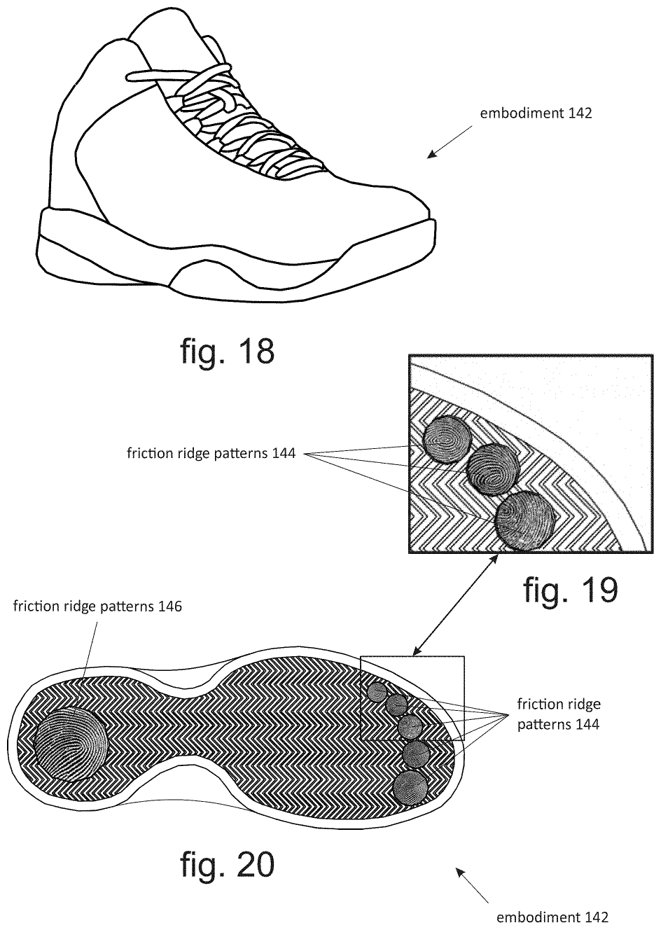

FIGS. 18, 19, and 20 show embodiment 142 which is a basketball shoe with friction ridge patterns 144 imprinted below the toes of the shoed foot, and friction ridge patterns 146 imprinted below the heel of the shoed foot. Such an arrangement might help both visually convey, as well as practically exhibit the advantages of using friction ridge patterns.

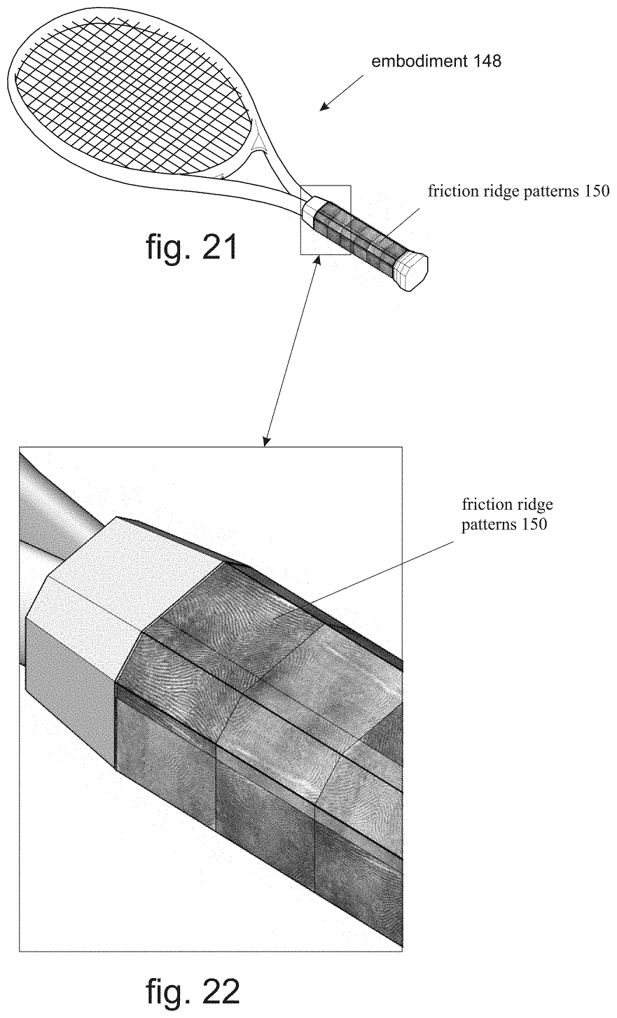

FIGS. 21 and 22 show embodiment 148, which is a tennis racket with friction ridge patterns 150 embossed into, or projecting from, its handle. This may be done utilizing many different fabrication techniques, including, but not limited to, molding, insert molding, stamping, handle wrapping tape, or any other useful means.

Friction ridge patterns may also be advantageously fabricated into the handles of rackets for: badminton, racquetball, ping-pong, as well as handles for other sports equipment.

Likewise, these may be friction ridge patterns of, or derivative of friction ridge patterns of, celebrities, including, but not limited to sports celebrities. Here again, such patterns may help reinforce the value of celebrity endorsements.

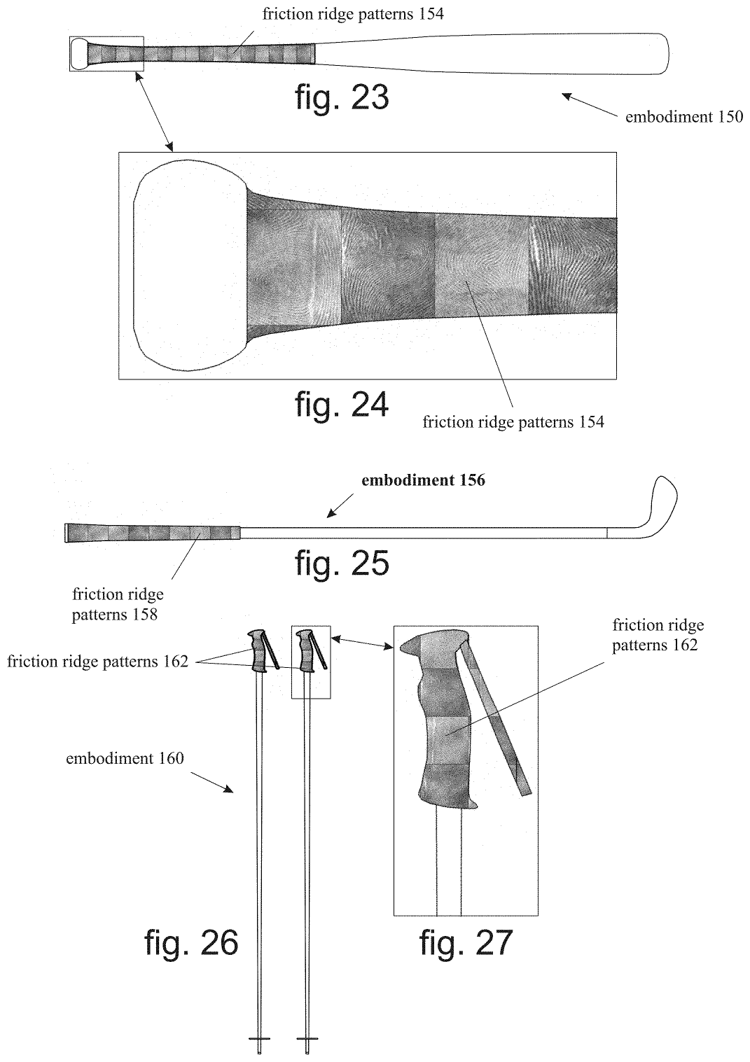

FIGS. 23 and 24 show embodiment 152, which is a baseball bat with friction ridge patterns 154 indented into, or projecting from, its handle. As with all friction patterns shown or described herein, these friction ridge patterns may be taken from, or be a derivative of, friction ridge patterns of celebrities who endorse the product. Again this may reinforce the value of a celebrity endorsement, as well as help to enhance the performance of the equipment.

FIG. 25 shows embodiment 156, which is a golf club with friction ridge patterns 158 formed into, or projecting out from its handle.

FIGS. 26 and 27 show embodiment 160, which comprises a pair of ski poles, each with a handle and retainer strap with friction ridge patterns 162 formed into them.

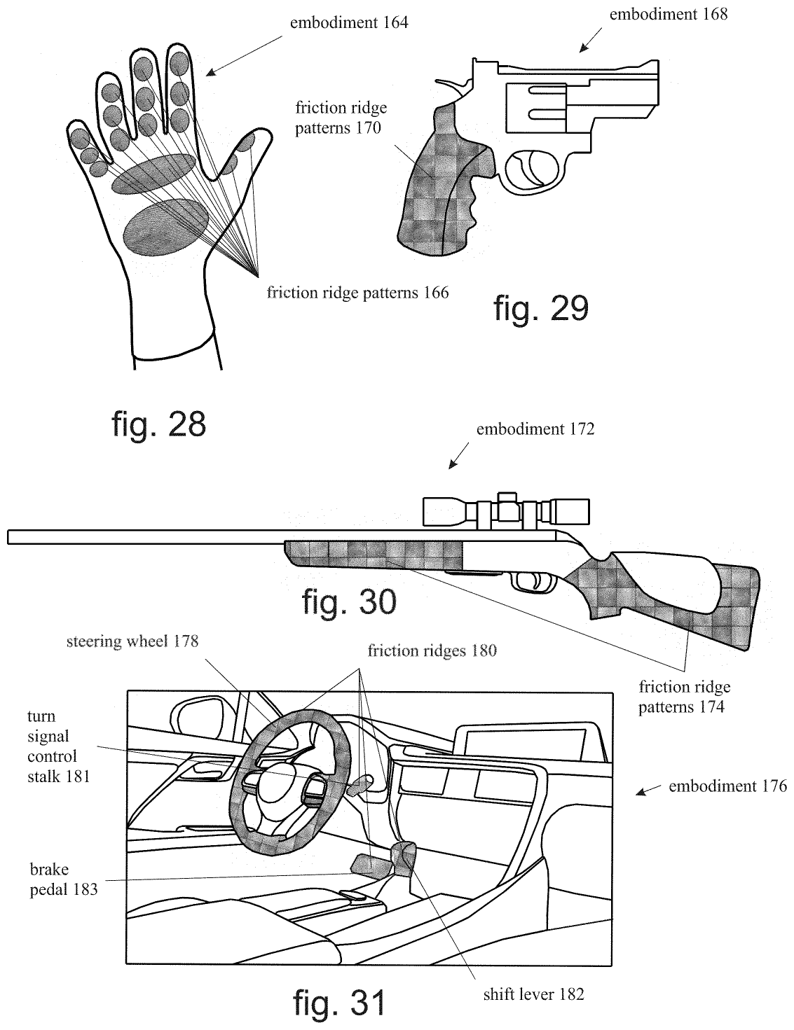

FIG. 28 shows embodiment 164, which is a glove with friction ridge patterns 166 formed into its palm, inner finger and thumb surfaces. Such gloves may be adapted to a variety of uses, including, but not limited to, use in sports such as, by way of nonlimiting and nonexhaustive examples: baseball, hockey, basketball, football, climbing, track and field, as well as other sport and recreational activities. Such gloves also may be adapted to activities, such as driving exercise, painting, rowing, and other activities. Such friction ridge patterns, as with all friction ridge patterns described and illustrated herein, may imitate, and/or may duplicate, and/or may be derivative of, and/or may be a mixture of, any of the friction ridge patterns shown and described herein, including specifically, but not limited to, those shown in FIGS. 1 through 35 and described in accompanying descriptions.

FIG. 29 shows embodiment 168, which is a pistol with friction ridge patterns 170 formed into its handle. Such a design may, as non-limiting and non-exhaustive examples, be adapted and used for both military and civilian use arms.

FIG. 30 shows embodiment 172, which is a rifle with friction ridge patterns 174 formed into manually gripped and contacted surfaces. As non-limiting and non-exhaustive examples, adaptations of this may be used for both sports and military purposes.

FIG. 31 shows embodiment 176, which is the interior of a vehicle having friction ridges 180 formed into steering wheel 178, shift lever 182, brake pedal 183, turn signal control stalk 181 and accelerator pedal (not shown). Again this may be done for celebrity endorsement enhancement, and/or to increase vehicle performance, and/or for other reasons. This may be done also, as non-limiting and non-exhausted examples, for other vehicles, including, but not limited to: trucks, buses, construction equipment, aircraft, marine craft, go carts, agricultural equipment, military vehicles, etc.

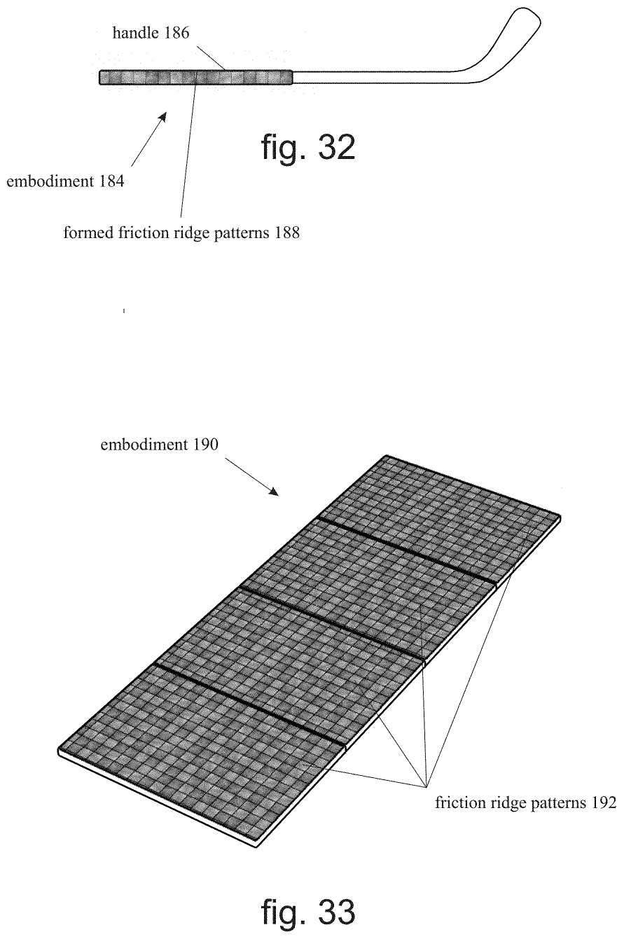

FIG. 32 shows embodiment 184, which is a hockey stick with handle 186 having formed friction ridge patterns 188.

FIG. 33 shows embodiment 190, which is an exercise mat with friction ridge patterns 192 formed in its surface. Such friction ridge patterns 192 may be adapted to all kinds of floor covering purposes, including specifically, but not limited to: yoga mats, play surfaces, exercise surfaces, and other horizontal as well as vertical traction surfaces.

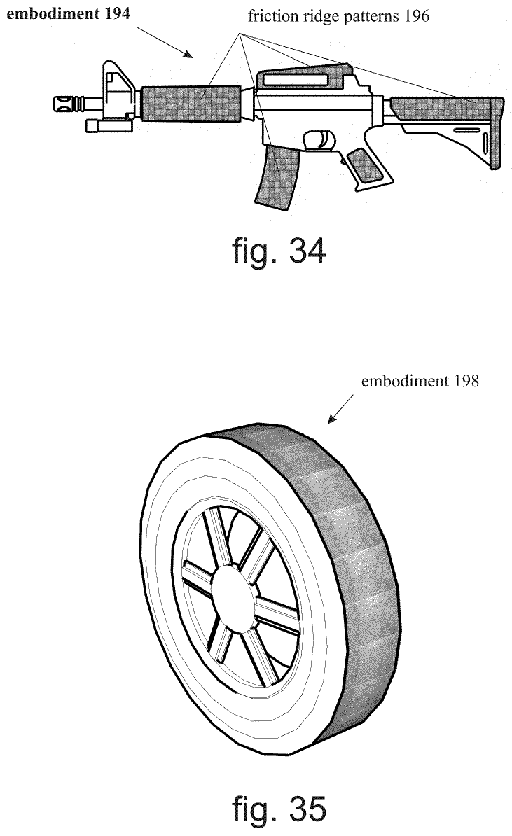

FIG. 34 shows embodiment 194, which is a military style assault rifle, with friction ridge patterns 196 formed into various sections which are manually gripped or contacted. Again these friction ridge patterns may enhance performance in critical situations.

FIG. 35 shows embodiment 198, which is an automobile tire with friction ridge patterns formed into its tread to potentially increase performance and improve celebrity endorsement power.

Any effective arrangement of friction ridge patterns, including those described herein, may be used alone and/or in combination, and/or at any useful scale, and/or at any effective relief contours, and/or utilizing any compatible fabrication technique, to potentially increase the performance of products, and/or to enhance the effectiveness of celebrity endorsements for such products, and/or for other reasons. This is true for any of a wide variety of products, including specifically those described herein.

As non-limiting and non-exhausted examples, such products may include: footwear (including footwear for: track, track and cross-country running, marathons, climbing, baseball, basketball, football, track and field, swimming, snorkel and skin diving, tennis, golf, boating, rowing, auto racing, weightlifting, all sports, work, dress and/or leisure wear, gymnastics, hunting, fishing, and other indoor and outdoor activities, etc.); gloves and hand wear for the above activities, as well as handles and gripping surfaces on products including, but not limited to: tennis, badminton, squash, and racquetball rackets; ping-pong paddles; golf clubs, croquet mallets, hockey sticks, yard utensils, including shovels, rakes, trowels, lawnmowers, weed whackers, cythes; power and manual hand tools, automobile steering wheels, aircraft yokes and joysticks, bicycle and motorcycle handle grips, military and sports rifles and pistols; hand grips on weapons such as grenade launchers and surface to air rocket launchers; floor coverings such as tumbling, yoga, and exercise mats, and area and general floor and wall surfaces; hand and foot gripping and contact areas, including those on: gym equipment, eating utensils, automobile and other device control pedals; knives and cutlery; archery bows; appliance and tool handles; bottles, jars and containers; door knobs, stair and other railings; as well as other gripping and contact areas on other products including automobile and other tires, and tractor treads; as well as gripping and contact areas on other products.

1. A method to enhance an individual endorsement of a product comprising the steps of:
recording a friction ridge pattern of an individual endorsing a product, and
forming a three dimensional derivation of the recorded friction ridge pattern into the product endorsed by the individual.

2. The method of claim 1 further including advertising in media that the product endorsed by the individual includes the friction ridge pattern derived from the individual endorsing the product.

3. The method of claim 1, further including the endorsed product being configured specifically for use in an athletic activity.

4. The method of claim 1, further including the formed friction ridge pattern being at the same scale as the recorded friction ridge pattern.

5. The method of claim 1, further including the formed friction ridge pattern being enlarged in scale from the recorded friction ridge pattern.

6. The method of claim 1, further including the formed friction ridge pattern being reduced in scale from the recorded friction ridge pattern.

7. The structure of claim 1, further including the formed friction ridge pattern being derived from a professional sports competitor.

8. The method of claim 1, further including the endorsed product being a footwear product.

9. The method of claim 3, further including the endorsed product being a baseball bat, hockey stick, tennis racket, racquetball racket, squash racket, badminton racket, ping-pong paddle, golf club, or ski pole; with the formed three dimensional derivation of the recorded friction ridge pattern is disposed on a handle portion of the endorsed product.

10. An athletic footwear product with versatile performance, comprising:
an upper enclosure configured to surround upper and rear portions of a foot,
a sole coupled on its periphery to a lower portion of the upper enclosure, and
the sole having a downward directed lower face, and
wherein the lower face is three dimensionally imprinted with a friction ridge pattern derived from an individual.

11. The athletic footwear product of claim 10, further including the imprinted friction ridge pattern being imprinted at a same scale as the friction ridge pattern derived from an individual.

12. The athletic footwear product of claim 10, further including the imprinted friction ridge pattern being imprinted at an enlarged scale from the friction ridge pattern derived from an individual.

13. The athletic footwear product of claim 10, further including the imprinted friction ridge pattern being imprinted at a reduced scale from the friction ridge pattern derived from an individual.

14. A versatile firearm grip, comprising a firearm including a gripping handle portion, wherein the gripping handle portion is three dimensionally imprinted with a friction ridge pattern derived from an individual.

15. The versatile firearm grip of claim 14, wherein the firearm is a member of the set: pistol, rifle, grenade launcher, and surface to air rocket launcher.

16. A versatile vehicle control hand interface, comprising vehicle control hand interface gripping surface, disposed on a steering wheel, brake pedal, accelerator pedal, gearshift, or turn direction signal stalk, wherein the hand interface gripping surface is three dimensionally imprinted with a friction ridge pattern derived from an individual.

17. A glove having versatile gripping surfaces, comprising:
a glove, including hand enveloping surfaces comprising gripping areas configured to contact objects being grasped, wherein the gripping areas are three dimensionally imprinted with friction ridge patterns derived from an individual.

18. A vehicle tire with a versatile tread surface, comprising vehicle tire, including a tread surface, wherein the tread surface is three dimensionally imprinted with a friction ridge pattern derived from an individual.

19. A horizontal floor surface, comprising an upward directed foot contacting surface, wherein the upward directed foot contacting surfaces being three dimensionally imprinted with friction ridge patterns derived from an individual.

20. The floor surface of claim 19, wherein the foot contacting surface is both padded and resilient.
